(19) United States
(12) Patent Application Publication
(10) Pub. No.: US 2001/0041200 A1
(43) Pub. Date: Nov. 15, 2001

(54) COMPOSITION AND METHOD FOR FLOCKING OF BISCUITS AND OTHER FOOD PRODUCTS

(76) Inventor: JEAN GROLLET, SAINT ETIENNE (FR)

Correspondence Address: VENABLE, POST OFFICE BOX 34385, WASHINGTON, DC, 200439998

(21) Appl. No.: 09/242,257

(22) PCT Filed: Aug. 12, 1997
(86) PCT No.: PCT/FR97/01485

§ 371 Date: None

(30) Foreign Application Priority Data
Aug. 14, 1996 (FR) 9610268

(51) Int. Cl. A23L 1/05; A23P 1/08

(52) U.S. Cl. 426/94; 426/306; 426/573; 426/99; 118/29

(57) ABSTRACT

According to the invention, a coating is carried out with a chocolate composition (C, 6) measured out with high gravimetric precision, and a 100% natural preparation of vegetable additives in an alcohol base (A, 3, 4, 5) is atomized. The combination of the alcohol-based preparation with the coating layer causes a surface reaction (R) which, with the evaporation of the alcohol, forms a glossy to semi-glossy and slightly resistant structure. The range for the application of the coating (C, 6) is 29-39° C.; the finished product is not greasy to the touch; there is a substantially improved preservation of its appearance and shelf life.

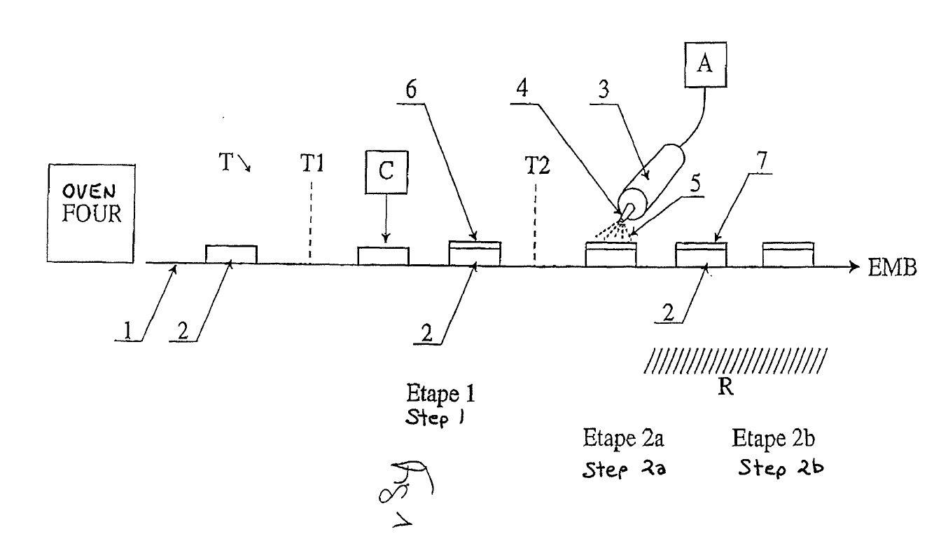

The present invention relates to a novel composition for the “chocolate coating” of all food bases, including “soft” products, particularly cookies and similar products.

The term “coating” is used herein to designate all operations for completely or partially covering a food product with a layer of a composition that is also a food. Hence, this term includes dipping, enrobing, etc. “Chocolate coating” designates the compositions comprising cocoa, cocoa butter and other, similar compositions, thus by extension nutritive, decorative or protective compositions, for example based on sugars, syrups, caramels, or creams, which may or may not contain alcohol, and similar compositions known to one skilled in the art.

The invention applies to the technical sector of the “coating” or “chocolate coating,” in the above sense, of “hard” or “soft” food products such as cookies, cakes, baked goods, pastries and the like.

The invention will be described in greater detail in connection with the coating of cookies or cakes, which are “soft” base products, but naturally only as a non-limiting example.

The current state of the art consists of depositing a layer of “chocolate” or another similar type of composition, using methods such as dipping, enrobing by other means, deposit by pouring, etc. These known techniques result in the obtainment of layers that are often relatively thick (unless the thickness is reduced by means of additional, hence industrially expensive, operations) and whose thickness is often difficult to control.

The lack of control over the thickness results in irregularities and, more detrimental to the industry, the use of a greater quantity of composition than necessary (for safety) which obviously results in excessive costs. Moreover, this technique does not allow for the treatment of designs in relief on the base.

According to these techniques, the precision of the application is naturally low, in terms of the positioning of the layer.

Furthermore, it is not effective for coating “soft” base products. The current techniques actually use “turbines,” which are rotating vats tilted by 45°, which are loaded with the product to be coated, then with the batch of coating. It is set in rotation, heated for most of the time, and the coated product is then removed. For almonds, dragees, pralines and the like, it is possible to obtain a glossy appearance with an additional coating of talc or with the separate application of a glaze.

However, this technique is unsuitable for treating soft products such as cookies, cakes, chocolate objects and the like, which crumble and stick.

The invention, on the other hand, is just as suitable for soft products as it is for hard products.

Another well-known drawback of the current techniques resides in the occurrence of rancidity (the presence of fats or milk in the composition of the product), which severely limits shelf life.

In addition, the current processes make the product “greasy” to the touch, which is unpleasant to the consumer.

For the manufacturer, another major drawback resides in the fact that the current compositions are very temperature sensitive. If the temperature is too low, the application does not work, or occurs under very poor conditions due to a lack of fluidity. If the temperature is too high or too low, the composition becomes denatured and, in particular, can whiten.

In practice, one skilled in the art knows that it is imperative for the manufacturer to stay within a range of only a few degrees, which is very precisely defined for the normal “chocolate” compositions as being from 29- 32° C.

The narrowness of this range naturally results in strict constraints when it comes to the systems that control the industrial equipment.

A whitening, caused by temperature variations, is also observed over time, a factor which also limits the shelf life of the product, and alters its taste.

Naturally, these drawbacks are recognized, and for several decades, particularly since the appearance of so-called “industrial” cookie-making, improvements have been made, but without any definitive progress.

In particular, despite the known drawbacks, the industry has not been able to eliminate either the drawbacks mentioned above, or the strict temperature constraints relative to application and preservation.

There is therefore an important need at the so-called “industrial” cookie-making level, which includes “pastry-making” and baked goods, as well as pastry products.

It is completely surprising to note that the invention provides a solution to all of the problems indicated above.

As will be explained, the invention actually makes it possible to bring the range for the application of “chocolate” compositions to 29-39° C., this seven-degree increase in the temperature tolerance representing an absolutely remarkable development for the manufacturer, which needs to be considered in terms of its true value; shelf life is increased by several days, several weeks, or even several months depending on the type of product treated, which also represents definite progress; on the purely commercial level, the deposited layer has a very attractive, glossy appearance (which can be adjusted from glossy to more semi-glossy) and is not “greasy” to the touch; finally, depending on the product treated, rancidity occurs far less quickly.

This set of properties, some of which lead to the appearance on the market of radically novel products, is obtained, in a preferred method, by a process according to which a composition characterized by the simultaneous presence of a food-grade alcohol and an alcohol-soluble ingredient or ingredients hereinafter referred to as “vegetable additives,” constituted by certain specific substances from vegetable sources, are sprayed or atomized over the layer of coating.

According to this preferred variant of the invention, it is necessary to arrange for a certain contact time between the layer of coating and the surface layer in order to allow enough time for a reaction to take place between the two layers.

Without intending to be limited by any particular theory, the Applicant maintains that the surface appearance obtained, as well as the final texture obtained, can only be explained by the occurrence of such a reaction.

In an entirely preferred way, the surface composition is deposited by being sprayed or atomized onto the layer of coating, this technique allowing a high level of precision and promoting the rapid evaporation of the alcoholic component.

It is possible that this evaporation directly or indirectly influences the reaction, even though the alcohol evaporates very quickly.

The invention can also be used to provide the desired degree of impermeability (or resistance to taking on water, water vapor, or ambient humidity) for products such as waffles or any other “moist” pastry, and the like. In this equally advantageous application, it is possible to apply an alcohol and “vegetable-additive” composition so as to form a thin covering, which actually results from the reaction of the sprayed composition with certain constituents of the dough. This “covering,” by virtue of its formation via a reaction of a chemical nature, can be so thin that it takes the form of more of a “surface treatment” (which modifies the surface layer of the waffle or of any other product considered herein) than a “covering” in the strictest sense.

The invention allows the composition to be applied with very high precision, both in terms of the dosage and in terms of its disposition on the surface. Thus, it is possible to deposit the atomized composition according to the invention on a cookie that is inside is paper wrapper, without soiling the latter, as long as certain elementary precautions are taken. In addition, the loss of product around the treated pastry is limited. Decorative effects become possible.

The invention also has the advantage of resulting in an entirely natural product.

Naturally, as a function of the intended applications, the invention can also use any of the conventional food-grade additives used by one skilled in the art.

The invention also relates to the composition intended to be sprayed onto a layer of coating in accordance with a preferred method of implementation, which is characterized in that it comprises at least one food-grade alcohol and at least one food-grade “vegetable additive” as defined below.

Alcohols of this type are known and are chosen from among the so-called “neutral” food-grade alcohols, i.e., constituted by alcohol and a small proportion of water. Flavors, or even natural colorants that are compatible with the alcohol can be added, and must specifically be soluble in it.

The “vegetable additives” used according to the invention are constituted by a selection of products of the “shellac” type. It is known that these products are obtained from a resinous exudation that solidifies on the young branches of plants such as Rhamus jujuba and Fucus rengiosa. Shellac is a product that is intrinsically known and can be either a brown gum or a white gum, possibly in powder form or in “flakes” for brown gum (or even “blonde” gum). Shellacs are soluble in alcohol, which is an essential criterion according to the invention. This criterion specifically excludes the known sugar-based coatings or the talc-glazing carried out in a turbine.

Surprisingly, the shellac and the alcohol are the two essential components of the invention.

Other combinations were actually tried, based on the knowledge of the prior art, such as:

alcohol+shellac+sugar>>> sticky coating and long drying time;

alcohol+shellac+glycerine>>> a reaction occurs that produces a sticky result and an extremely unpleasant taste.

It is possible to incorporate other vegetable products, preferably Peru balsam (with a strong aromatic fragrance, and resulting in a reddish-brown color), and or Benjamin gum (a pleasant vanilla-like fragrance).

Peru balsam is insoluble in water but is soluble in absolute alcohol in any proportion, and exists in the form of a syrupy liquid; specifically, it is an extract of Toluifera pereirae.

Benjamin gum is a natural balsam produced by benzoin resin, which is soluble in alcohol and melted by heat.

As indicated above, the Applicant has observed the formation according to the preferred variant of the invention of a completely original structure, which it attributes, without intending to be limited by any particular theory, to a surface reaction or modification between the alcoholic composition of vegetable additives and the treated substrate. The alcohol seems to fulfill an essential function and so, probably, does the method of application by atomization or spraying, which promotes rapid evaporation. However, it is probable that the additive or additives cooperate with the whole. One skilled in the art will know how to determine by means of simple, routine tests which additives fulfill this function of cooperating with the alcohol.

The invention also relates to a device for “coating” cookies, cakes, pastries, baked goods, moist pastry products, and the like, characterized in that it comprises, after the means for implementing the coating operation, a means for applying an alcoholic composition of at least one “vegetable additive,” which reacts as defined above, onto the layer of coating, after which there is a sufficient contact time before the wrapping operation to allow a slightly rigid structure to form. “Slightly rigid” designates the obtainment of a surface that is slightly crispy, or even non-crispy, which is non-greasy to the touch, and glossy to semi-glossy.

The crispy quality and the glossy or matte quality (the appearance of the chocolate) can be adjusted by means of the proportion of shellac, in accordance with routine tests.

The sole figure represents the preferred mode of implementation of the process according to the invention.

1st Step

As it leaves the baking oven, the cookie (or the like) is carried (2) on a conveyer belt (1) into an area in which, at the temperature T1(known to one skilled in the art), it receives the “chocolate coating,” from a heated vat and delivery equipment such as a pump, etc., in the 29-39° C. range made surprisingly accessible according to the invention, via a spraying or atomizing means represented globally by “C.” The cookie (2) bearing the coating (6) then passes into a cooling tunnel in order to be brought to the temperature T2, which is that of the natural consistency of the chocolate, or about 18 to 20° C.

It is possible to provide an element (not represented) for cooling the base (2) to temperatures of 0° C. or lower, in order to obtain special appearances of the “velvety” type; it is important to note that the obtainment of such very attractive effects is impossible with the current techniques, on an industrial scale.

2nd Step

2a) Using means that are known or within the scope of one skilled in the art, globally represented by “A,” the composition according to the invention is brought (in accordance with the particularly preferred method of implementation), to one or more movable and positionally controlled application nozzles (3, 4), and the composition (5) according to the invention is then sprayed or atomized.

Naturally, this equipment is thermoregulated.

These application elements are similar or identical to the means “C” for applying the coating.

Provided at the level of the nozzle or atomizer (3, 4) is a stainless steel mesh conveyor with a return through alcohol-based cleaning means, and preferably a fume hood for eliminating or recuperating the vapors.

2b) The cookie (2) bearing the “treated” coating (7) then passes through a reaction area “R,” which may be ventilated, for a sufficient amount of time for the alcohol to evaporate and for the above-mentioned surface reaction to occur simultaneously. Depending on the product involved, the retention time will be on the order of several seconds to several dozen seconds.

The elimination of the alcohol is very quick (several seconds). Here again, simple tests will enable one skilled in the art to determine the appropriate holding time.

It will be noted that, when it comes to the choice of additives and the precise working conditions, one skilled in the art could apply his own expertise in order to obtain a product that is more or less crispy, more or less glossy or matte, more or less aromatic or colored, etc., and hence suitably adapted to his own clientele. This is also one of the reasons why, once the inventive concept of depositing a reactive alcoholic composition of “vegetable additive(s)” onto the coating is introduced, it is impossible to define all of the methods for implementing the invention.

The coated cookie then reaches the wrapping area EMB.

An exemplary “chocolate coating” composition is given below:

A. Coating Composition

A product based on chocolate, cocoa butter, and vegetable fats, approximating a percentage of 40% cocoa (the tests were reproduced with comparable results using 20 and 45% cocoa). The percentages of cocoa and cocoa butter can therefore be adjusted so as to obtain the desired quality and to adapt to the standards in force.

The following is a preferred exemplary coating composition; it is a combination that makes it possible to use a spraying or atomization process:

1 kg of dark chocolate glazing paste, known to one skilled in the art

400 g of “couverture,” also known (cocoa butter, cocoa and sugar)

150 g of vegetable fat, which modifies the texture and provides flavor, in accordance with the melting point of the fat.

When a special velvety or similar type of appearance is sought, it is possible using routine tests to research the best possible combination between the choice of the application temperature within the 29-39° C. range and the temperature of the base (2), possibly cooled as indicated above.

It will be noted that the techniques of the prior art use a glazing paste or a couverture diluted with cocoa butter, or a couverture diluted with corn oil, peanut oil or sunflower oil, which generates rancidity.

According to the invention, it is also possible, based on need and on the industrial objectives, to combine a normal dipping followed by a spraying of the coating.

Physical Appearance

When cooled, a better consistency than the traditional glazing pastes.

Utilization temperature (between 29 and 39° C.: fluidity allowing easy application with technical means that ensure productivity no matter what the production rate required by the manufacturer. This widened range of 29 to 39° C. is obtained through the use of an original means of application, which is expressly part of the invention, and which consists of spraying or atomizing means identical to the means (3, 4, 5) of step 2a.

This spraying allows proper treatment of designs in relief on the base, which is impossible with the techniques of the prior art.

Gustatory Value

More pronounced taste of fine chocolate, less doughy to the palate and without any unpleasant aftertaste, all of which can be adjusted by one skilled in the art (flavors, etc.).

Color

The possibility of a deep brown of a high-end chocolate.

The reactive composition of the treatment according to the invention corresponds, in the preferred embodiment, to the definition below:

B. Alcoholic Composition

A neutral alcohol-based product and at least one 100% natural vegetable additive as defined above, with an alcohol content on the order of 96%, or possibly lower (85%).

A preferred exemplary composition is:

750 g of 96° alcohol

350 g of shellac

resulting in a content on the refractometer (dry solution) of 40-45°.

Increasing the proportion of shellac will increase the hardness, the glazed appearance and the glossiness.

A more advanced composition is:

750 g of 96° alcohol

350 g of shellac

30 g of Peru balsam

250 g of Benjamin gum.

or:

1 1 of 96° alcohol

200 g of shellac

20 g of Benjamin gum,

which formulation provides a treatment that is less hard and more matte, having practically the same appearance as the chocolate.

It is possible to finish with a dusting of sugar and other known decorative operations.

The very quick evaporation of the alcohol resulting from the process according to the invention is an additional advantage, since the product obtained has a residual alcohol content near zero, which corresponds to the current market trends.

Physical Appearance

A syrupy liquid similar in viscosity to a syrup containing 40-45° on the refractometer (dry solution).

Color

It has two different appearances in terms of color, depending on the bases to be treated: either an opaque brown, or a translucent brown (a color similar to that of cognac).

Gustatory Value

Possibly a slightly crispy feel to the teeth, similar to the crystallization of a syrup, without any particular taste.

One skilled in the art will understand that, starting from this preferred composition and the general object of the invention, it is possible to vary the alcohol content, the viscosity, etc., in order to obtain the desired result, which can be verified by means of routine tests.

It is also possible to use mixtures of alcohols, and naturally, to incorporate additives such as colorants and soluble flavorings. Preferably, these additives are chosen from the natural product range, so as not to alter one of the important advantages of the invention, i.e., the totally natural quality of the product.

There is no limit to the possible applications. They include all pastries or cookies, fresh or dried, soft or hard, etc., sugared or salted, that are capable of receiving a coating for both gustatory and presentational purposes.

For example, treatments were carried out on cones for ice cream, cookies, including those presented in their baking papers, cakes, and the like.

C. Process

The implementation of the invention requires only a few equipment modifications: a temperature-controlled vat; heated, thermoregulated hoses for transporting the substance; application nozzles pre-defined as a function of the production rate, possibly driven in oscillating motions as a function of the products to be coated, and a stainless steel mesh conveyer (if none exists) at the level of the treatment area.

Coating

Coating, even partial coating, of all types of bases, even moist ones, while precisely controlling the quantity of coating on the product involved.

Moreover, the temperature utilization margin (from 29 to 39° C.) is greater than any product currently existing on the market and thus makes it possible to simplify the handling of transportation and application problems.

A mesh conveyer with a scraping system is used.

Application of the Coating

A vat (to be provided or already existing), heated by means of a water bath or air space, in order to avoid direct contact with the heating equipment and with slow stirring of the product.

A pump (type to be defined as a function of the production rate) for delivery to the application point.

Heated tube thermoregulated between 29 and 39° C.

One or more nozzles for application by spraying or atomizing, predefined based on need, with oscillating motions or lateral displacements, also defined as a function of the forms of the products to be treated, or equivalent spraying or atomizing means.

According to a variant, the invention also relates to the utilization of such means to deposit the layer of coating, even without any subsequent treatment of this layer.

Cooling tunnel (theoretically already existing on the production lines).

According to a variant, the invention also relates to the separate process (i.e., without the subsequent treatment of the coating layer) for applying the coating layer onto the base or substrate, characterized in that it comprises the spraying or atomization of the coating composition onto the base or substrate using the means described above.

Treatment

To be applied as soon as the coating has acquired its final consistency.

It makes it possible, after a very short drying time, to produce an exceptional glossy or semi-glossy appearance, to preserve flavors, to prevent sticking to wrappers as well as marks on the product, an important factor in marketing, no matter what the external ambience, and to protect the consumer from the unpleasantness of soiled hands. It increases the preservation of the treated product, making it possible to fully guarantee the “sell by” date, or even exceed it.

Application of the Treatment

Positioning the atomizer that allows the protection to be applied (nozzle defined based on need) at the outlet of the cooling tunnel.

This requires a stainless steel mesh conveyor with a return through an alcohol-based cleaning system.

Stainless steel feed vat and feeding of the atomizer by gravity and/or aspiration.

According to another variant, the invention also relates to a process for treating a base or substrate of the type described in the present application which has not received the coating layer, characterized in that an alcoholic composition as defined above is applied directly onto said base or substrate by spraying or atomization.

1. Process for an improved “coating” of cookies, pastries, baked goods, cakes, waffles or other moist pastry products, and any soft or hard food product or base or the like, characterized in that a coating of said base is carried out, and in that a composition comprising at least one food-grade “vegetable additive” in solution in at least one food-grade alcohol is deposited on the coating layer.

2. The process according to claim 1, characterized in that the vegetable additive is comprised of a shellac, and can possibly contain other alcohol-soluble additives, such as Peru balsam and/or Benjamin gum.

3. The process according to claim 1 or 2, characterized in that the coating composition is a combination of dark chocolate glazing paste, couverture and vegetable fat, which allows the application of the coating by spraying or atomization.

4. The process according to claim 3, characterized in that the coating composition comprises a combination that makes it possible to use a spraying or atomizing process:
1 kg of dark chocolate glazing paste, known to one skilled in the art
400 g of “couverture,” also known (cocoa butter, cocoa and sugar)
150 g of vegetable fat, which modifies the texture and provides flavor, in accordance with the melting point of the fat.

5. The process according to any of claims 1 through 4, characterized in that the temperature for the application of the coating can be chosen within the range of 29 to 39° C.

6. The process according to any of claims 1 through 5, characterized in that the temperature for the application of the coating can be chosen within the range of 29 to 39° C., and the base (2) can be cooled to 0° C. or to a lower temperature.

7. The process according to any of claims 1 through 6, characterized in that said alcoholic composition of vegetable additive(s) is applied as soon as the coating has reached its natural consistency.

8. The process according to any of claims 1 through 7, characterized in that a contact time of several seconds to several dozen seconds is ensured between the coating layer and said alcoholic composition, before proceeding to the wrapping of the product.

9. The process according to any of claims 1 through 8, characterized in that the deposit of said alcoholic composition onto the coating layer is carried out by spraying or atomization.

10. The process according to any of claims 1 through 9, characterized in that the coating applied is a “chocolate coating.”

11. A composition for improving a coating for cookies, pastries, baked goods, cakes, waffles or other moist dough products, and any similar food product, characterized in that it comprises a base of at least one neutral food-grade alcohol and at least one reactive vegetable extract soluble in said alcohol base.

12. The composition according to claim 11, characterized in that it comprises:
750 g of 96° alcohol
350 g of shellac, resulting in a content on the refractometer (dry solution) of 40-45° C.

13. The composition according to claim 11, characterized in that it comprises:
750 g of 96° alcohol
350 g of shellac
30 g of Peru balsam
250 g of Benjamin gum.

14. The composition according to claim 11, characterized in that it comprises:
1 l of 96° alcohol
200 g of shellac
20 g of Benjamin gum.

15. The composition according to any of claims 1 through 14, characterized in that it also comprises flavorings and normal food additives, which are preferably natural and soluble in the alcohol base.

16. A device for the improved coating of cookies, pastries, baked goods, cakes, waffles or other moist pastry products, and any comparable food product, characterized in that it comprises, after the means for implementing the coating operation, a means for applying an alcoholic composition of at least one reactive vegetable additive onto the coating layer, followed by a sufficient contact time before the wrapping operation to allow the formation of a slightly rigid structure, from several seconds to several dozen seconds.

17. The device according to claim 16, characterized in that it comprises means for applying the coating at a temperature that can be chosen from between 29 and 39° C.

18. The device according to either of claims 16 or 17, characterized in that it comprises a stainless steel mesh conveyor with a return through a system for alcohol-based washing and for recuperation of the alcoholic composition and the vapors formed.

19. The device according to any of claims 16 through 18, characterized in that the coating itself is applied using a spraying or atomizing technique.

20. The device according to any of claims 16 through 18, characterized in that the coating itself is applied using a spraying or atomizing technique in combination with a preliminary enrobing.

21. A process for treating a base or substrate of the type described in claim 1, which has not received a coating layer, characterized in that an alcoholic composition as defined in claims 11 through 15 is applied directly to said base or substrate by spraying or atomization.

22. A separate process for applying the coating layer to the base or substrate, characterized in that it comprises the spraying or atomization of the coating composition onto the base or substrate using spraying or atomizing means such as nozzles, which are preferably positionable.

23. Products such as cookies, pastries, baked goods, cakes, waffles or other moist dough products, and any comparable food products, whether hard or soft, sugared or salted, characterized in that they have been obtained by using or implementing a process, a composition and/or a device according to any of claims 1 through 22.
